(19) United States
(12) Patent Application Publication
(10) Pub. No.: US 2023/0105847 A1
(43) Pub. Date: Apr. 6, 2023

(54) METHOD AND SYSTEM TO DETERMINE A MASK LEAKAGE RATE

(71) Applicant: Colorado State University Research Foundation, Fort Collins, CO (US)

(72) Inventors: Christian L'Orange, Fort Collins, CO (US); John Volckens, Fort Collins, CO (US); David Leith, Chapel Hill, NC (US); Casey Quinn, Olympia, WA (US); Bonnie Young, Fort Collins, CO (US); John Kodros, Fort Collins, CO (US)

(21) Appl. No.: 17/960,029

(22) Filed: Oct. 4, 2022

Related U.S. Application Data
(60) Provisional application No. 63/252,052, filed on Oct. 4, 2021.

(51) Int. Cl. G01M 3/26; A62B 27/00

(52) U.S. Cl. CPC G01M 3/26; A62B 27/00

(57) ABSTRACT

A system may include a computer-readable storage media configured to store instructions. The system may also include one or more processors communicatively coupled to the one or more computer-readable storage media. The one or more processors may be configured to, in response to execution of the instructions, cause the system to perform operations. The operations may include measuring a pressure of a volume while a user wears a mask and breathes. The volume may be defined by an interior surface of the mask and a face of the user. The operations may also include determining a differential pressure due to the mask. The differential pressure may be equal to a difference between the pressure of the volume and an ambient pressure of an environment proximate an exterior surface of the mask. In addition, the operations may include determining a mask leakage rate of the mask based on the differential pressure.

### CROSS-REFERENCE TO RELATED APPLICATION

This patent application claims the benefit of and priority to U.S. Provisional App. No. 63/252,052 filed Oct. 4, 2021, titled “METHOD AND DEVICE TO ESTIMATE PPE MASK LEAKAGE RATES IN-SITU,” which is incorporated in the present disclosure by reference in its entirety.

### FEDERALLY SPONSORED RESEARCH AND DEVELOPMENT

This invention was made with Government support under grant K01 OH011598 awarded by the Centers for Disease Control and Prevention. The Government has certain rights in the invention.

### FIELD

The embodiments discussed in the present disclosure are related to a method and system to determine a mask leakage rate.

### BACKGROUND

Unless otherwise indicated in the present disclosure, the materials described in the present disclosure are not prior art to the claims in the present application and are not admitted to be prior art by inclusion in this section.

A mask (e.g., a personal protective equipment (PPE) mask or respirator) may be designed to protect a user from various hazards including urban air pollution, smoke, dust, and infectious bioaerosols. In addition, the mask may be designed to reduce an emission of infectious particles (e.g., infectious bioaerosols) by the user. The mask may include a particle filtering mask, a respirator, or other face coverings. An amount of protection provided by the mask may be predicated on proper mask selection, mask fit (e.g., a fit of the mask), and use of the mask. For example, a sufficient level of the mask fit, a sufficient filtration rate of the mask, a sufficient breathability of the mask, and/or appropriate wearing of the mask by the user may increase the amount of protection provided by the mask. Mask leakage (e.g., an amount of air going around the mask) may depend on individual-level factors such as a facial shape of the user, a donning procedure by the user, and a behavior of the user.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One or more embodiments of the present disclosure may include a system that includes one or more computer-readable storage media configured to store instructions. The system may also include one or more processors communicatively coupled to the one or more computer-readable storage media. The one or more processors may be configured to, in response to execution of the instructions, cause the system to perform operations. The operations may include measuring a pressure of a volume while a user wears a mask and breathes. The volume may be defined by an interior surface of the mask and a face of the user. The operations may also include determining a differential pressure due to the mask. The differential pressure may be equal to a difference between the pressure of the volume and an ambient pressure of an environment proximate an exterior surface of the mask. In addition, the operations may include determining a mask leakage rate of the mask based on the differential pressure.

One or more embodiments of the present disclosure may include a method. The method may include measuring a pressure of a volume while a user wears a mask and breathes. The volume may be defined by an interior surface of the mask and a face of the user. The method may also include determining a differential pressure due to the mask. The differential pressure may be equal to a difference between the pressure of the volume and an ambient pressure of an environment proximate an exterior surface of the mask. In addition, the method may include determining a mask leakage rate of the mask based on the differential pressure.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates a block diagram of an example operational environment of a pressure system;

FIG. 2A illustrates an example of the computing device of FIG. 1;

FIG. 2B illustrates example information that the computing device of FIG. 1 may display;

FIG. 3A illustrates a front view of a pressure system attached to a mask being worn by a user;

FIG. 3B illustrates a perspective cross sectional view of the pressure system attached to a mask being worn by the user;

FIG. 3C illustrates a back view of the pressure attached to the mask;

FIG. 4 illustrates an example operational environment of the pressure system;

FIG. 5 illustrates a graphical representation of simulations of the differential pressure measured by the pressure system of FIG. 1 compared to a reference measurement measured by a test device for a range of pressures;

FIG. 6 illustrates a graphical representation of a time resolved pressure trace;

FIG. 7 illustrates a flowchart of an example method of determining a mask leakage rate of a mask, and

FIG. 8 illustrates a block diagram of an example computing system,

all according to at least one embodiment described in the present disclosure.

### DETAILED DESCRIPTION

The amount of protection provided by the mask may be based on the filtration rating of the mask, the mask fit, or some combination thereof. The filtration rating may refer to an ability of the mask to remove particles from air that passes through the mask, either upon inhalation or exhalation. The mask fit may refer to an ability of the mask to seal against a face of the user (e.g., an ability of the mask to prevent air from flowing around the mask). A well-fitting mask may increase an amount of air that passes through the mask by preventing air from going around the mask.

Generalizing the mask fit based on a large population may be problematic as many factors influence how well the mask seals to the face of the user. These factors may include presence of facial hair on the user, a face size of the user, a face shape of the user, a breathing rate of the user, a mask size, a mask shape, a material of the mask, or some combination thereof. The mask fit may be characterized at an individual level to be accurate and representative of personal protection for the user.

The mask fit may be tested using a quantitative test or a qualitative test (e.g., fit tests). The quantitative test may be performed in a laboratory or other controlled environment. During the quantitative test, the mask may be sealed to a test apparatus and exposed to a test aerosol. A particle measuring device (e.g., a portacount) may measure a concentration of the test aerosol upstream of the mask (e.g., outside the mask). In addition, the particle measuring device may measure a concentration of the test aerosol downstream of the mask (e.g., inside the mask or in a volume defined by an interior surface of the mask and a surface of the test apparatus). The mask fit may be determined based on the concentration of the test aerosol upstream of the mask versus the concentration of the test aerosol downstream of the mask.

The qualitative test may also determine the mask fit and may include a pass or fail result. For the qualitative test, the mask may be worn by the user and exposed to the test aerosol. The user may determine if they taste or smell the test aerosol inside the mask. If the user smells or tastes the test aerosol, the mask fails the qualitative test (e.g., a fail result). If the user does not smell or taste the test aerosol, the mask passes the qualitative test (e.g., a pass result).

The quantitative test may only test inhalation leakage (e.g., inward leakage when the user inhales) of the mask. This is because the quantitative test only determines if the test aerosol reaches the inside of the mask. In addition, the quantitative tests may result in the mask being irreversibly altered (e.g., a permanent hole may be made in the mask). Further, the quantitative test may use costly test aerosols, expensive equipment, and trained technicians. For example, the particle measuring device may costs ten thousand dollars or more. The quantitative test may damage at least one mask per conducted test, may prevent the mask from being used after testing due to the damage, and may make it impractical to perform “spot-check” style testing of the mask.

The qualitative test may also only test inhalation leakage of the mask. This is because the qualitative test only determines if the test aerosol reaches the user. In addition, the qualitative test may use costly test aerosols. For example, a qualitative fit test kit may cost several hundred dollars and may include the test aerosol for every test.

The quantitative test and the qualitative test may make it impractical for members of the public and for workers outside of workplace respiratory protection programs to test the mask fit. In addition, the quantitative test and the qualitative test may not determine and/or quantify mask leakage of infectious bioaerosols when the user exhales, coughs, vocalizes, or some combination thereof.

The quantitative test and the qualitative test may assume the mask provides perfect filtration (e.g., zero particles pass through the mask). The quantitative test and the qualitative test may then attribute all particles detected inside the mask to leakage despite the possibility that some of the particles penetrate the mask. The quantitative test and the qualitative test may limit testing the mask fit to short durations of time due to being physically connected to a stationary piece of equipment (e.g., the test apparatus), exposed to the test aerosol, or some combination thereof.

Some embodiments described in the present disclosure may include a pressure system configured to test the mask fit in a non-destructive and scalable manner. In addition, the pressure system may determine the mask fit (e.g., measure mask leakage) during inhalation of the user, exhalation of the user, or both inhalation of the user and exhalation of the user. The pressure system may provide a reliable way to test mask fit for populations and in situations in which the qualitative test and/or the quantitative test are impractical. In some embodiments, the pressure system may measure a pressure drop across the mask (e.g., a filter material) during controlled inhalation and/or exhalation maneuvers by the user.

The pressure system may include a lightweight and compact sensor that can be attached to the interior surface of the mask. The sensor may monitor pressure inside the mask (e.g., the volume between the interior surface of the mask and the face of the user) in real-time. The pressure system may determine the mask leakage rate based on a difference in pressure during breathing by the user relative to an expected pressure for a perfectly sealed mask. In addition, the pressure system may determine the pressure drop based on a relationship between a breathing rate of breathing of the user and a breathing volume of the user.

The pressure system may include one or more computer-readable storage media configured to store instructions. The pressure system may also include one or more processors communicatively coupled to the one or more computer-readable storage media. The processors may be configured to, in response to execution of the instructions, cause the pressure system to perform operations. The pressure system may measure a pressure of the volume while the user wears the mask and breathes. The volume may be defined by the interior surface of the mask and a face of the user. The pressure system may also determine a differential pressure due to the mask. The differential pressure may be equal to a difference between the pressure of the volume and an ambient pressure of an environment proximate an exterior surface of the mask. In addition, the pressure system may determine a mask leakage rate of the mask based on the differential pressure.

The pressure system may provide a non-destructive, quantitative, in-situ test of the mask fit. The pressure system may conduct the test of the mask fit on the user wearing the mask without damaging the mask. The pressure system may also create no waste and the user may continue to use the mask after the test of the mask fit.

The pressure system may provide a reliable method to test the mask fit and to determine whether the mask is well-fitting or poorly-fitting. The pressure system may also perform a rapid fit test for both inhalation and exhalation of the user. In addition, the pressure system may perform the test of the mask fit without damaging the mask. Further, the pressure system may be used in combination with the quantitative test. The pressure system may identify, with a detection rate of 0.065 millimeters of mercury (mmHg) and a 3× signal-to-noise ratio, mask leakage at a rate roughly equal to one percent (e.g., a high flow resistance mask with fast breathing) and fifteen percent (e.g., a low flow resistance mask with slow breathing).

The pressure system may provide testing of mask fit to the public. The pressure system may be simpler than the quantitative test because the pressure system does not include expensive instrumentation or use the test aerosol. The pressure system may be used with minimal training and supplies making the pressure system more appropriate for public use. The pressure system may also be relatively cheaper than the equipment for the quantitative test. For example, the pressure system may be equal to or less than one hundred dollars. The pressure system may be implemented to perform large-scale mask fit testing. For example, for the example cost of one particle measuring device, roughly one hundred pressure systems could be acquired and used to test the mask fit on one hundred different people simultaneously.

The pressure system may measure the mask fit for extended periods of time. For example, the pressure system may remain attached to the mask and test the mask fit over a period of time that is greater than an amount of time the test aerosol will be present.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

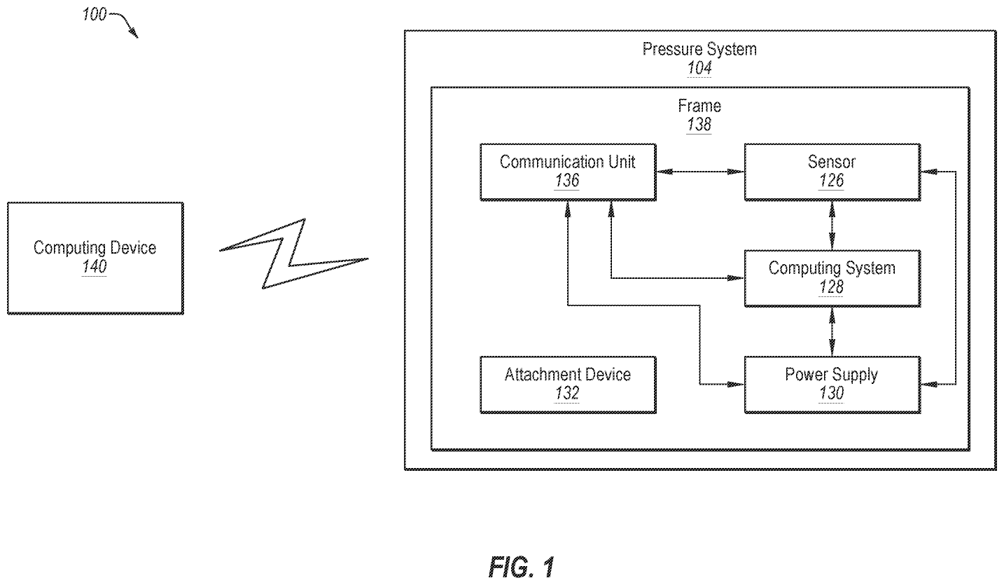

FIG. 1 illustrates a block diagram of an example operational environment 100 of a pressure system 104, in accordance with at least one embodiment described in the present disclosure. The environment 100 may include the pressure system 104 and a computing device (e.g., an external device) 140. The pressure system 104 may include a sensor 126, a computing system 128, a power supply 130, an attachment device 132, a communication unit 136, and a frame 138. The computing system 128 may be communicatively coupled to the sensor 126 and the communication unit 136. In addition, the pressure system 104 (e.g., the communication unit 136) may be communicatively coupled to the computing device 140.

The computing system 128 may include any suitable special-purpose or general-purpose computer, computing entity, or processing device including various computer hardware or software modules and may be configured to execute instructions stored on any applicable computer-readable storage media. For example, the computing system 128 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

The communication unit 136 may include any component, device, system, or combination thereof that is configured to transmit or receive data between the pressure system 104 and the computing device 140. The communication unit 136 may include a modem, a network card (wireless or wired), an infrared communication device, a wireless communication device (such as an antenna), and/or chipset (such as a Bluetooth® device, an 802.6 device (e.g., Metropolitan Area Network (MAN)), a WiFi device, a WiMax device, cellular communication facilities, etc.), and/or the like.

The power supply 130 may provide energy (e.g., power) to the sensor 126, the computing system 128, the communication unit 136, or some combination thereof. The power supply 130 may include a rechargeable battery. For example, the power supply 130 may include a lithium-ion polymer rechargeable battery. In some embodiments, the power supply 130 may include a seventy-milliamp hour 3.7-volt lithium-ion polymer configured to provide energy sufficient to operate the pressure system 104 for roughly forty-five minutes on a single charge.

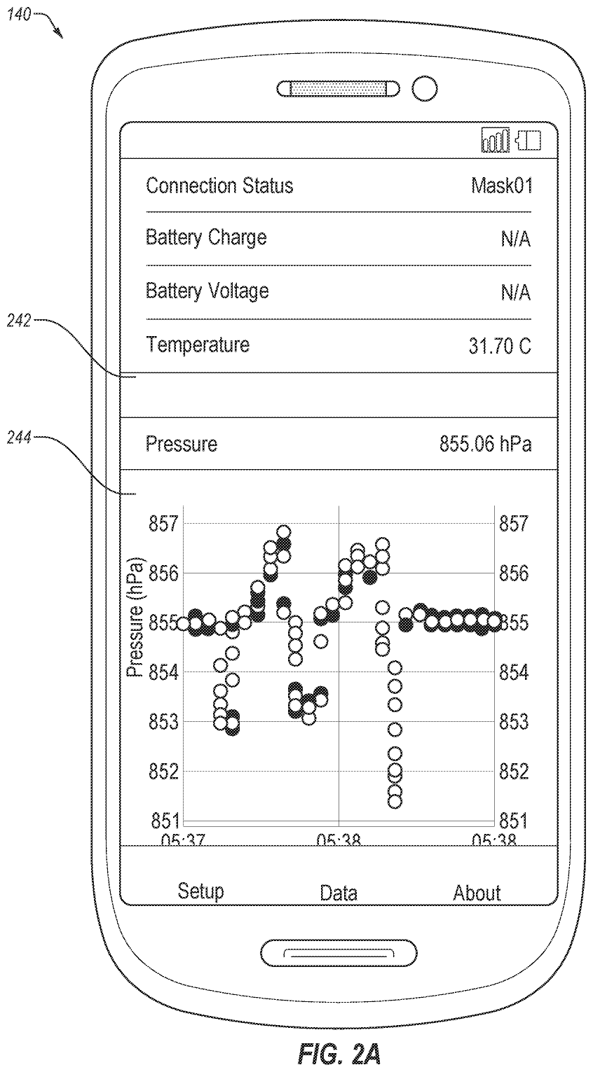

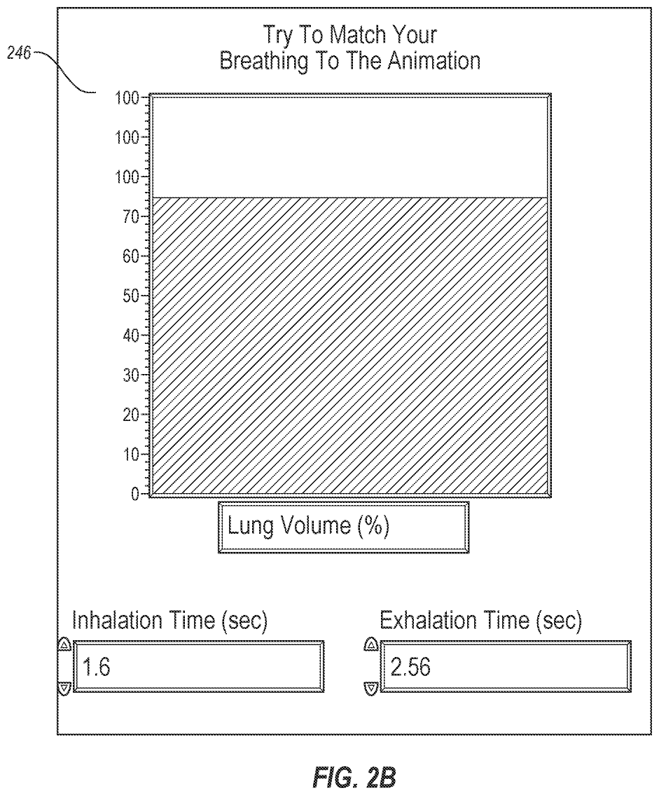

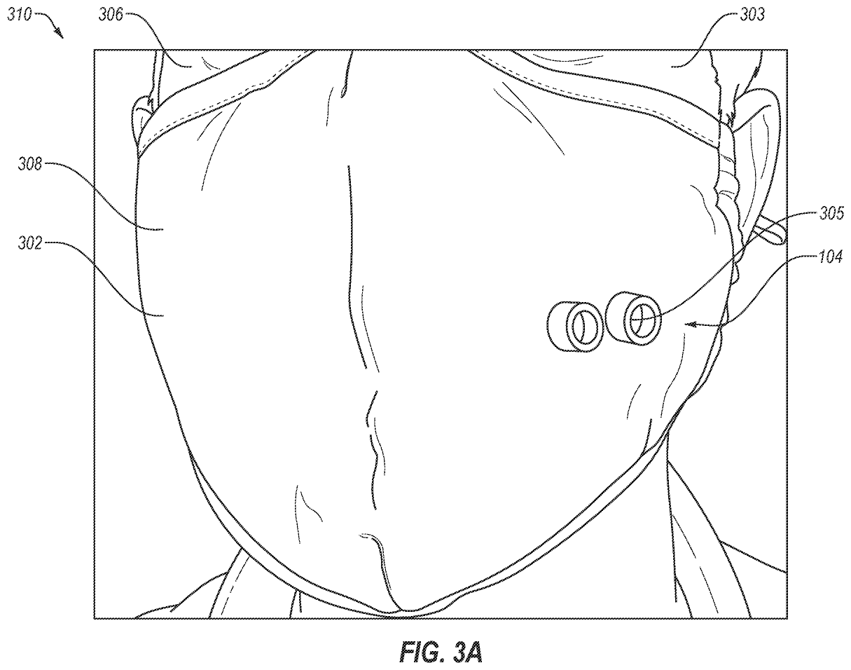

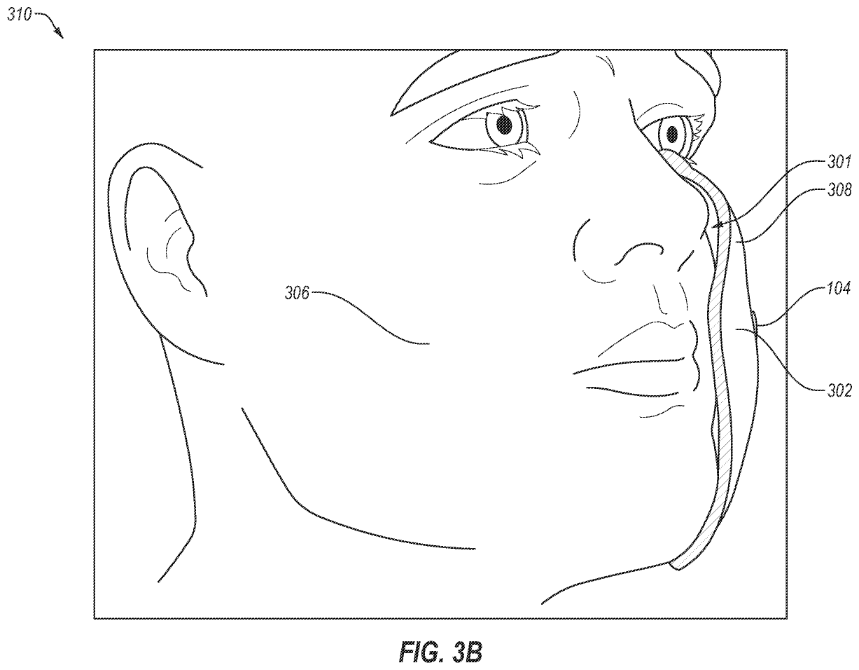

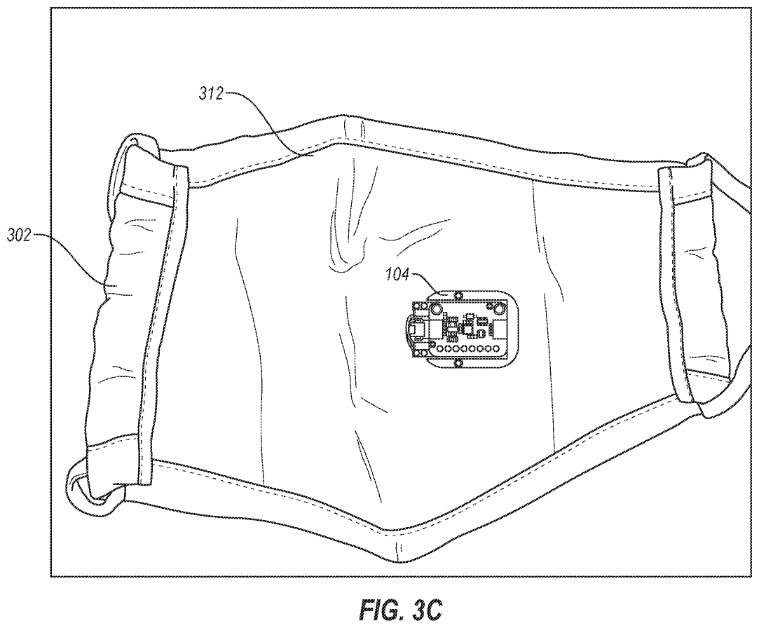

The sensor 126 may include a micro-electro-mechanical system (MEMS) pressure transducer. The sensor 126 may generate data representative of the pressure of the volume (illustrated in FIG. 3B) while the user wears the mask and breathes. The sensor 126 may measure the pressure inside the volume after a period of time of elapses. For example, the sensor 126 may measure the pressure inside the volume everyone one hundred milliseconds. The sensor 126 may provide data representative of the pressure in the volume to the communication unit 136 to provide to the computing device 140. In some embodiments, the computing device 140 may display the data representative of the pressure in the volume in real-time via a display, which is discussed in more detail below in relation to FIGS. 2A and 2B.

The frame 138 may house the sensor 126, the computing system 128, the power supply 130, the communication unit 136, or some combination thereof. The frame 138 may house only a portion of the sensor 126 to expose a portion of the sensor 126 to the volume. The frame 138 may be mechanically coupled to the sensor 126, the computing system 128, the power supply 130, the communication unit 136, or some combination thereof. The frame 138 may include a plastic material, a metal material, or some combination thereof.

The frame 138 may be mechanically coupled to the attachment device 132 to permit the attachment device 132 to selectively attach the pressure system 104 to the mask. The attachment device 132 may selectively attach the pressure system 104 to the mask so as to physically position the sensor 126 and the frame 138 proximate the interior surface of the mask as discussed below in relation to FIG. 3C. The attachment device 132 may include multiple magnets (e.g., embedded magnets and separate magnets). The separate magnets may be configured to interface with the embedded magnets to selectively attach the pressure system 104 to the mask. For example, the separate magnets may be configured to be physically positioned proximate the exterior surface of the mask and the embedded magnets, along with the frame 138, may be configured to be physically positioned proximate the interior surface of the mask. In some embodiments, the attachment device 132 may include neodymium magnets.

An example in which the pressure system 104 is used to characterize the mask will now be discussed. The pressure system 104 may characterize the mask by measuring and comparing a flow rate of the mask to a pressure drop due to the mask (generally referred to in the present disclosure as “pressure drop”). The pressure system 104 may be used to characterize the flow rate, the pressure drop, or some combination thereof of the mask. In some embodiments, the mask may be attached to a semi-flexible test apparatus (e.g., a mannequin head) and edges of the mask may be sealed to the test apparatus (e.g., sealed using liquid silicone) to reduce and/or eliminate mask leakage. A flow sweep may be performed using the test apparatus and the pressure system 104. The pressure system 104 may measure a differential pressure across the mask during the flow sweep. The differential pressure may include a pressure within the volume defined by the interior surface of the mask and the test apparatus and an exterior environment (e.g., an environment proximate the exterior surface of the mask).

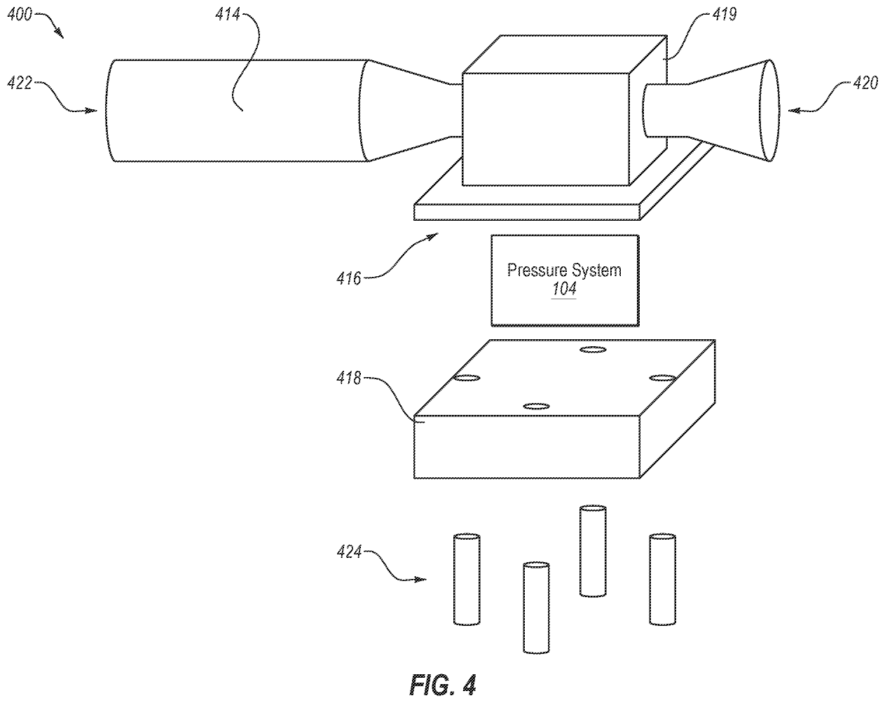

An example in which the pressure system 104 is used to characterize a tidal volume (e.g., a calibrated tidal volume) of the user will now be discussed. The pressure system 104 may be mechanically coupled to a flow meter. In some embodiments, the flow meter may include a venturi flow meter, a hot wire anemometer, a mass flow meter, a positive displacement meter, or any other appropriate flow meter. The sensor 126 may be physically positioned within a volume defined by the flow meter. The flow meter is discussed in more detail below in relation to FIG. 4. The pressure system 104 may instruct the computing device 140 to display breathing instructions to the user via the computing device 140. The breathing instructions may guide the user through a series of breathing exercises using the flow meter. An example of the breathing instructions being displayed via the computing device 140 is discussed below in relation to FIGS. 2A and 2B.

The sensor 126 may measure the pressure within the volume defined by the flow meter. The sensor 126 may provide data representative of the pressure within the volume defined by the flow meter to the computing system 128. The computing system 128 may determine the calibrated tidal volume of the user based on the measured pressure, a duration of the inhalation of the user, a duration of the exhalation of the user, or some combination thereof. The computing system 128 may also determine an inhalation flow rate (IFR) of the user and an exhalation flow rate (EFR) of the user based on the calibrated tidal volume.

An example in which the pressure system 104 determines the mask fit when the mask is worn by the user will now be discussed. In some embodiments, the pressure system 104 may instruct the computing device 140 to display the breathing instructions to the user. The breathing instructions may guide the user through the series of breathing exercises while the user wears the mask. In other embodiments, the pressure system 104 may not provide the breathing instructions and the mask fit may be determined using nominal breathing of the user.

The sensor 126 may measure the pressure of the volume (e.g., the volume defined by the interior surface of the mask and the face of the user and upstream of the mask) while the user wears the mask and breathes. The sensor 126 may provide data representative of the pressure of the volume to the computing system 128. The computing system 128 may determine the differential pressure due to the mask. In some embodiments, the differential pressure may be equal to a difference between the pressure of the volume and an ambient pressure of the environment proximate the exterior surface of the mask (e.g., the pressure downstream of the mask).

In some embodiments, the computing system 128 may determine the flow rate of the mask while the user wears the mask and breathes based on the differential pressure. In these and other embodiments, the computing system 128 may estimate the breathing rate and/or the tidal volume of the user based on aspects of the user. The aspects of the user may include a gender, an age, a height, a weight, body measurements, a level of physical fitness, a health status, a smoking status, or a chest diameter, or some combination thereof of the user. In some embodiments, the health status of the user may include whether the user has asthma, chronic obstructive pulmonary disease, or any other respiratory disease or ailment. In these and other embodiments, the smoking status may include a number of cigarettes per day the user smokes, an amount of time the user has smoked, a smoking type of the user (e.g., the user smokes filtered cigarettes, smokes non-filtered cigarettes, smokes a cigar, smokes a pipe, or some combination thereof). In these and other embodiments, the chest diameter of the user may be based on physical chest dimensions of the user. Alternatively, the computing system 128 may determine the breathing rate of the user using the breathing instructions and the calibrated tidal volume. In some embodiments, the computing system 128 may determine the tidal volume of the user based on a spirometry test, a carbon dioxide measurement, or some combination thereof.

The computing system 128 may determine the pressure drop based on the differential pressure. In some embodiments, the pressure drop may be determined based on the flow rate of the mask. The pressure drop may occur due to breathing resistance caused by drag forces from air flowing past fibers in the mask. In some embodiments, the computing system 128 may determine the expected pressure drop. The expected pressure drop may be determined based on the characterization of the mask as discussed above. Alternatively, the expected pressure drop may be determined based on information provided by the manufacturer of the mask.

In some embodiments, the relationship between the pressure drop and the flow rate of the mask (e.g., flow of air through the material of the mask) may be determined using Equation 1 (e.g., Darcy's Law).

$$v = \frac{K}{μ} ( \frac{\partial P}{\partial x} ) \qquad Equation 1$$

In Equation 1, κ represents the permeability of the material of the mask, μ represents the fluid viscosity of air, and

$$\frac{\partial P}{\partial x}$$

represents the pressure drop (e.g., a pressure gradient across the material of the mask). By assuming the cross-section of the mask does not change and that the material characteristics of the mask and the viscosity of air are approximately constant, Equation 1 can be rearranged to relate the pressure drop to volumetric flow as shown in Equation 2.

$$Q = \frac{c}{μ} * A * Δ P \qquad Equation 2$$

In Equation 2, Q represents the volumetric flow, c represents mask-specific factors such as material type, pore size, etc., μ represents the fluid viscosity of air, A represents the cross-sectional area of the mask and is typically constant for a mask, and ΔP represents the pressure drop. Equation 1 and Equation 2 can be employed to estimate the mask leakage rate by first characterizing the relationship between the flow rate of the mask and the pressure drop. Thus, in some embodiments, the computing system 128 may use Equation 1 and Equation 2 to determine the pressure drop if the breathing rate of the user is constant or reproducible, properties of the mask are known, or some combination thereof.

The computing system 128 may determine the mask leakage rate of the mask based on the differential pressure. In some embodiments, the computing system 128 may determine the mask leakage rate of the mask based on the difference between the pressure drop and the expected pressure drop. For example, the computing system 128 may determine the mask leakage rate based on the difference between the pressure drop during nominal breathing of the user and the expected pressure drop. In some embodiments, the computing system 128 may generate pressure traces comparing the pressure drop versus the expected pressure drop.

The computing system 128 may provide data representative of the mask leakage rate, the pressure traces, or some combination thereof to the communication unit 136 to provide to the computing device 140. The computing device 140 may display the mask leakage rate, the pressure traces, or some combination thereof to the user. The pressure traces may inform the user of the mask leakage rate both during inhalation and exhalation.

An example in which the computing system 128 performs a calibrated flow method to determine the mask leakage rate will now be discussed. The computing system 128 may use the calibrated tidal volume, a calibrated breathing rate, or some combination thereof of the user as part of the calibrated flow method. The calibrated flow method may permit the computing system 128 to determine the mask leakage rate as flow-dependent (e.g., the mask leakage rate may vary throughout the breathing cycle of the user), which may minimize bias due to varying mask leakage rates by using the calibrated tidal volume of the user.

The computing system 128 may determine an expected inhalation differential pressure (IDP) based on the IFR of the user. The computing system 128 may also determine an expected exhalation differential pressure (EDP) based on the EFR of the user. In addition, the computing system 128 may determine an IDP due to the mask. Further, the computing system 128 may determine an EDP due to the mask. In some embodiments, the differential pressure may include the IDP due to the mask, the EDP due to the mask, or some combination thereof.

The computing system 128 may determine a difference between the IDP and the expected IDP. The computing system 128 may also determine a difference between the EDP and the expected EDP. The mask leakage rate may be based on the difference between the IDP and the expected IDP, the difference between the EDP and the expected EDP, or some combination thereof. In some embodiments, in response to the difference between the IDP and the expected IDP being equal to or greater than a threshold value, the difference between the EDP and the expected EDP being equal to or greater than the threshold value, or some combination thereof, the computing system 128 may determine the mask fit fails (e.g., a fit of the mask and the user fails) and may provide data to the computing device 140 via the communication unit 136 to display a fail result to the user. In some embodiments, the fail result may indicate to the user that the mask fit is improper currently and may indicate certain actions that can be taken by the user to improve the mask fit. Alternatively, the fail result may indicate to the user that the mask is improper for the user. In these and other embodiments, in response to the difference between the IDP and the expected IDP being less than the threshold value, the difference between the EDP and the expected EDP being less than the threshold value, or some combination thereof, the computing system 128 may determine the mask fit passes (e.g., a fit of the mask and the user passes) and may provide data to the computing device 140 via the communication unit 136 to display a pass result to the user.

An example in which the computing system 128 performs an integral pressure method to determine the mask leakage rate will now be discussed. The computing system 128 may use the tidal volume of the user over time, the breathing rate of the user over time, or some combination thereof as part of the integral pressure method. An integral of the pressure drop-over-time may be associated with the tidal volume of the user, which may be used to determine the breathing rate of the user. The integral pressure method may permit the computing system 128 to determine the mask leakage rate for the entire breathing cycle of the user. The integral pressure method may permit the computing system 128 to determine the mask leakage rate of the mask for an uneven breathing pattern of the user.

The computing system 128 may estimate the tidal volume of the user (e.g., a calculated tidal volume) based on the gender, the age, the height, the weight, the level of physical fitness, the health status, the smoking status, the chest diameter, or some combination thereof of the user. The computing system 128 may also determine the IFR of the user, the EFR of the user, or some combination thereof based on the calculated tidal volume. In addition, the computing system 128 may determine the expected IDP based on the IFR based on the calculated tidal volume. Further, the computing system 128 may determine the expected EDP based on the EFR based on the calculated tidal volume.

The computing system 128 may determine the IDP due to the mask. The computing system 128 may also determine the EDP due to the mask. In some embodiments, the differential pressure may include the IDP due to the mask, the EDP due to the mask, or some combination thereof. In addition, the computing system 128 may determine the difference between the IDP and the expected IDP. Further, the computing system 128 may determine the difference between the EDP and the expected EDP. The mask leakage rate may be based on the difference between the IDP and the expected IDP, the difference between the EDP and the expected EDP, or some combination thereof. In some embodiments, in response to the difference between the IDP and the expected IDP being equal to or greater than the threshold value, the difference between the EDP and the expected EDP being equal to or greater than the threshold value, or some combination thereof, the computing system 128 may determine the mask fit fails and may provide data to the computing device 140 via the communication unit to display the fail result to the user. In these and other embodiments, in response to the difference between the IDP and the expected IDP being less than the threshold value, the difference between the EDP and the expected EDP being less than the threshold value, or some combination thereof, the computing system 128 may determine the mask fit passes and may provide data to the computing device 140 via the communication unit 136 to display the pass result to the user.

An example in which the computing system 128 performs a peak pressure method to determine the mask leakage rate will now be discussed. The computing system 128 may determine the mask fit using simple binary results (e.g., the fail result or the pass result) and the peak pressure method. The computing system 128 may determine the pass result occurs if a minimum level of the pressure drop that equates to a minimum mask leakage rate is measured. For example, the computing system 128 may determine the pass result occurs if the level of the pressure drop equates to a mask leakage rate of less than twenty percent of total flow. A peak differential pressure across the mask may occur with a peak inhalation flow by the user or a peak exhalation flow by the user. The computing system 128 may use the inherent relationship between the flow rate of air through the mask and the pressure drop to determine if the mask is sealing sufficiently. The computing system 128 may determine the mask leakage rate based on the inhalation flow rate of the user, the exhalation flow rate of the user, the relationship between the pressure drop and the flow rate of the mask, a minimum differential pressure that equates to the pass result, or some combination thereof. If a leak occurs (e.g., if air flows around the mask), the expected differential pressure may not occur. The computing system 128 may estimate the tidal volume, the breathing rate, or some combination thereof of the user to determine the mask leakage rate.

The computing system 128 may determine a peak inhalation volumetric flow, a peak exhalation volumetric flow, or some combination thereof in accordance with Equation 3.

$${\dot{V}}_{peak} = \frac{{\dot{V}}_{average * π}}{2} \qquad Equation 3$$

In Equation 3, \dot{V}_{average} represents the tidal volume divided by an inhalation time/exhalation time.

The computing system 128 may determine the calculated tidal volume based on the gender, the age, the height, the weight, the level of physical fitness, the health status, the smoking status, the chest diameter, or some combination thereof of the user. The computing system 128 may also determine a peak IFR (PIFR) of the user, a peak EFR (PEFR) of the user, or some combination thereof based on the calculated tidal volume. In addition, the computing system 128 may determine an expected peak IDP (PIDP) due to the mask based on the PIFR. Further, the computing system 128 may determine an expected peak EDP (PEDP) due to the mask based on the PEFR.

The computing system 128 may determine the PIDP due to the mask. The computing system 128 may also determine the PEDP due to the mask. In some embodiments, the differential pressure may include the PIDP due to the mask, the PEDP due to the mask, or some combination thereof. In addition, the computing system 128 may determine the difference between the PIDP and the expected PIDP. Further, the computing system 128 may determine the difference between the PEDP and the expected PEDP. The mask leakage rate may be based on the difference between the PIDP and the expected PIDP, the difference between the PEDP and the expected PEDP, or some combination thereof. In some embodiments, in response to the difference between the PIDP and the expected PIDP being equal to or greater than the threshold value, the difference between the PEDP and the expected PEDP being equal to or greater than the threshold value, or some combination thereof, the computing system 128 may determine the mask fit fails and may provide data to the computing device 140 via the communication unit to display the fail result to the user. In these and other embodiments, in response to the difference between the PIDP and the expected PIDP being less than the threshold value, the difference between the PEDP and the expected PEDP being less than the threshold value, or some combination thereof, the computing system 128 may determine the mask fit passes and may provide data to the computing device 140 via the communication unit 136 to display the pass result to the user.

FIG. 2A illustrates an example of the computing device 140 of FIG. 1, in accordance with at least one embodiment described in the present disclosure. FIG. 2B illustrates example information that the computing device 140 of FIG. 1 may display, in accordance with at least one embodiment described in the present disclosure. The computing device 140 may include a display 242 configured to display data to the user. For example, the display 242 may display the pressure traces, the test results, the breathing instructions, or any other appropriate data. The computing device 140 is illustrated as a smart phone in FIGS. 2A and 2B for exemplary purposes. The computing device 140 may include a smartphone, a desktop computer, a laptop computer, a tablet, a wearable device, or any other appropriate computing device that includes a display. The data may be displayed via a web browser, an application, or any other appropriate medium. For example, the computing device 140 may include a desktop computer that displays the information via a web browser. The computing device 140 may also receive user input indicating the aspects of the user. For example, the user input may indicate the gender, the age, the height, the weight, the body measurements, the level of physical fitness, the health status, the smoking status, the chest diameter, or some combination thereof of the user

The computing device 140 is illustrated in FIG. 2A as displaying a first example of data (referred to in the present disclosure as “the first example”) 244. The first example 244 includes information indicative of a charge state and a voltage state of the power supply 130, a current temperature of the operational environment 100, and a connection status between the computing device 140 and the pressure system 104 (e.g., via the communication unit 136). The first example 244 also includes a pressure trace indicating the pressure drop measured by the pressure system 104 over time. The information displayed via the display 242 may provide real time data to the user throughout the test of the mask fit test.

A second example information (referred to in the present disclosure as “the second example”) 246 is also illustrated in FIG. 2B. The second example 246 includes an example metronome (e.g., the breathing instructions) to guide the user through the breathing exercises. The metronome may assist the user achieve a repeatable breathing pattern. The metronome may assist the user to finish inhaling when the metronome is at a maximum and to finish exhaling when the metronome is at a minimum. For example, the metronome may assist the user to complete the breathing exercises using the flow meter.

FIG. 3A illustrates a front view of the pressure system 104 attached to a mask 302 being worn by a user 303, in accordance with at least one embodiment described in the present disclosure. FIG. 3B illustrates a perspective cross sectional view of the pressure system 104 attached to the mask 302 being worn by the user 303, in accordance with at least one embodiment described in the present disclosure. FIG. 3C illustrates a back view of the pressure system 104 attached to the mask 302, in accordance with at least one embodiment described in the present disclosure.

With combined reference to FIGS. 3A-3C, the pressure system 104 may be attached to an interior surface 312 of the mask 302. For example, the sensor 126, the computing system 128, the power supply 130, the communication unit 136, or some combination thereof may be attached to the interior surface 312. A portion of the attachment device 132 (e.g., the embedded magnets) may also be attached to the interior surface 312. In addition, another portion 305 of the attachment device 132 (e.g., the separate magnets) may be attached to an exterior surface 308 of the mask 302. The another portion 305 may be attached to the exterior surface 308 proximate an external environment 310. When the mask 302 is worn, as illustrated in FIGS. 3A and 3B, the pressure system 104 may be physically positioned in a volume 301 defined by a face 306 of the user 303 and the interior surface 312. In some embodiments, the pressure system 104 may be thirty-six millimeters (mm) by twenty-five mm by sixteen mm and weigh around nine grams.

FIG. 4 illustrates an example operational environment 400 of the pressure system 104, in accordance with at least one embodiment described in the present disclosure. The operational environment 400 may include the pressure system 104 and a venturi flow meter 414. The venturi flow meter 414 and the pressure system 104 may be used to determine the calibrated tidal volume, the calibrated breathing rate, or some combination thereof. The venturi flow meter 414 may include a base 418, a body 419, and fasteners 424. The pressure system 104 may be mechanically coupled to the base 418.

The fasteners 424 may attach the base to the body 419, which may define a volume 416 of the venturi flow meter 414. The body 419 may also define an inlet 420 and an outlet 422. The user may breathe into the inlet 420 and the air may traverse the volume 416 proximate the pressure system 104. The pressure system 104 may measure a pressure of the air within the volume 416 and the air may exit the volume 416 via the outlet 422. The venturi flow meter 414 may create a consistent internal pressure for different flow rates. For example, the venturi flow meter 414 may create an internal pressure of roughly thirty-five mmH₂O at a flow rate of fifteen liters per minute to simulate an N95 mask.

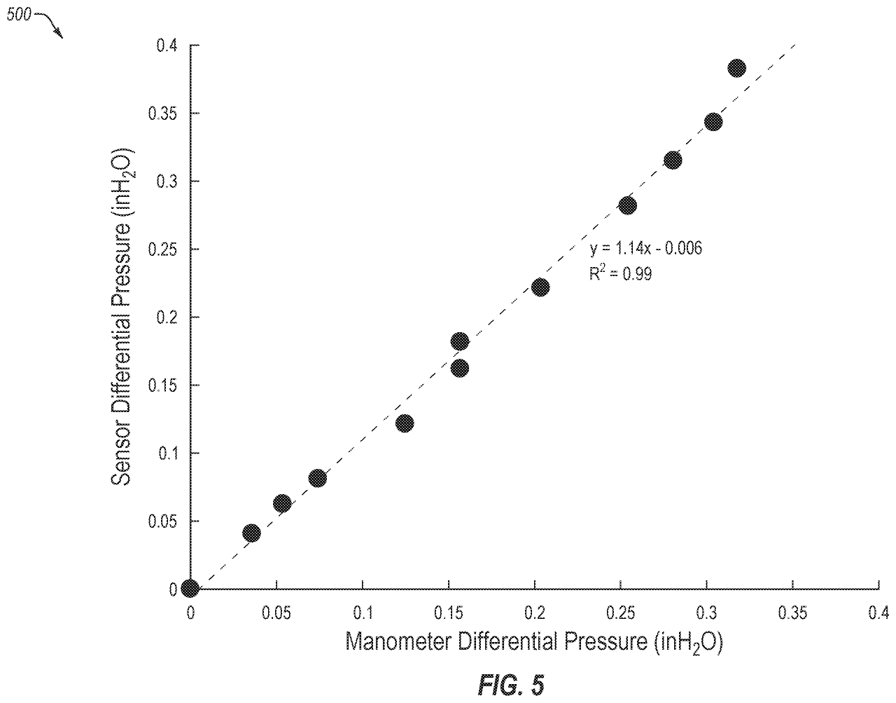

FIG. 5 illustrates a graphical representation 500 of simulations of the differential pressure measured by the pressure system 104 of FIG. 1 compared to a reference measurement measured by a test device for a range of pressures, in accordance with at least one embodiment described in the present disclosure. In FIG. 5, the circles represent where the differential pressure at a particular pressure and the corresponding reference measurement intersect. In addition, in FIG. 5, the dashed curve represents a linear regression between the differential pressures and the reference measurements over the different pressures. As shown in FIG. 5, the pressure system 104 measured the differential pressures linearly and relatively accurately compared to the corresponding reference measurements.

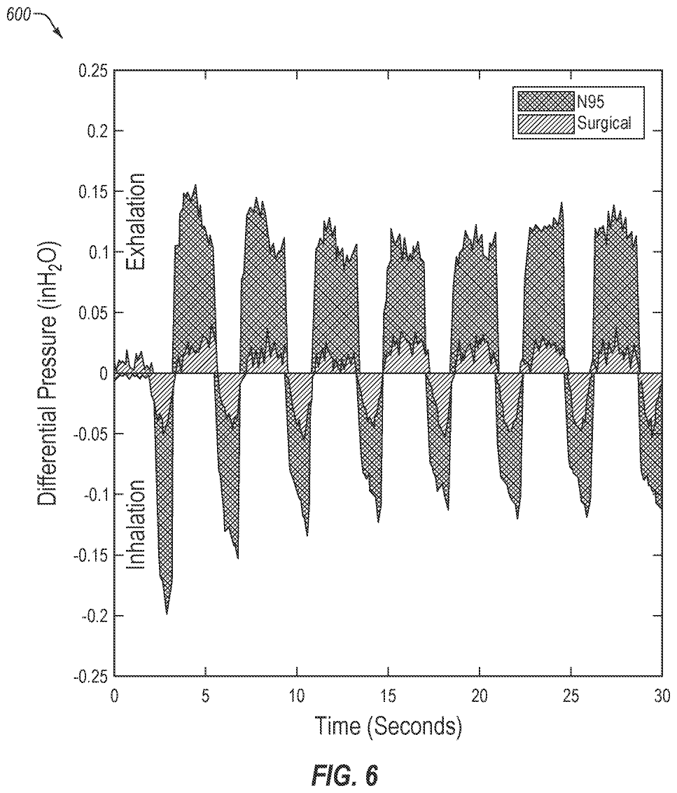

FIG. 6 illustrates a graphical representation 600 of a time resolved pressure trace, in accordance with at least one embodiment described in the present disclosure. The graphical representation 600 was generated based on data obtained by the pressure system 104. The data was representative of the differential pressure over time measured by the pressure system 104 while attached to an N95 mask and a surgical mask.

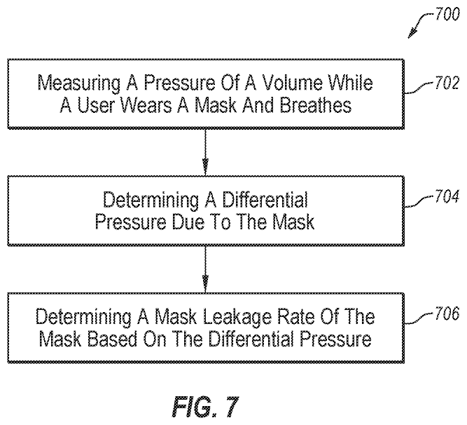

FIG. 7 illustrates a flowchart of an example method of determining a mask leakage rate of a mask, in accordance with at least one embodiment described in the present disclosure. The method 700 may be performed by any suitable system, apparatus, or device with respect to determining the mask leakage rate of the mask. For example, the pressure system 104 of FIG. 1 may perform or direct performance of one or more of the operations associated with the method 700 with respect to determining the mask leakage rate of the mask. The method 700 may include one or more blocks 702, 704, or 706. Although illustrated with discrete blocks, the steps and operations associated with one or more of the blocks of the method 700 may be divided into additional blocks, combined into fewer blocks, or eliminated, depending on the particular implementation.

At block 702, a pressure of a volume while a user wears a mask and breathes may be measured. The volume may be defined by an interior surface of the mask and a face of the user. At block 704, a differential pressure due to the mask may be determined. The differential pressure may be equal to a difference between the pressure of the volume and an ambient pressure of an environment proximate an exterior surface of the mask. At block 706, a mask leakage rate of the mask based on the differential pressure may be determined.

Modifications, additions, or omissions may be made to the method 700 without departing from the scope of the present disclosure. For example, the operations of method 700 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

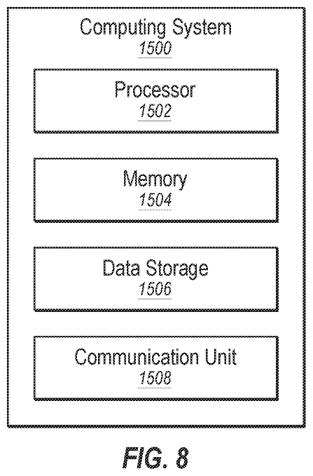

FIG. 8 illustrates a block diagram of an example computing system 1500, according to at least one embodiment of the present disclosure. The computing system 1500 may be configured to implement or direct one or more operations associated with the pressure system 104 of FIG. 1. The computing system 1500 may include a processor 1502, a memory 1504, a data storage 1506, and a communication unit 1508. The processor 1502, the memory 1504, the data storage 1506, and the communication unit 1508 may be communicatively coupled.

In general, the processor 1502 may include any suitable special-purpose or general-purpose computer, computing entity, or processing device including various computer hardware or software modules and may be configured to execute instructions stored on any applicable computer-readable storage media. For example, the processor 1502 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 8, the processor 1502 may include any number of processors configured to, individually or collectively, perform or direct performance of any number of operations described in the present disclosure. Additionally, one or more of the processors may be present on one or more different electronic devices, such as different servers.

In some embodiments, the processor 1502 may be configured to interpret and/or execute program instructions and/or process data stored in the memory 1504, the data storage 1506, or the memory 1504 and the data storage 1506. In some embodiments, the processor 1502 may fetch program instructions from the data storage 1506 and load the program instructions in the memory 1504. After the program instructions are loaded into memory 1504, the processor 1502 may execute the program instructions.

The memory 1504 and the data storage 1506 may include computer-readable storage media for carrying or having computer-executable instructions or data structures stored thereon. Such computer-readable storage media may include any available media that may be accessed by a general-purpose or special-purpose computer, such as the processor 1502. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 1502 to perform a certain operation or group of operations.

The communication unit 1508 may include any component, device, system, or combination thereof that is configured to transmit or receive information over a network. In some embodiments, the communication unit 1508 may communicate with other devices at other locations, the same location, or even other components within the same system. For example, the communication unit 1508 may include a modem, a network card (wireless or wired), an infrared communication device, a wireless communication device (such as an antenna), and/or chipset (such as a Bluetooth® device, an 802.6 device (e.g., Metropolitan Area Network (MAN)), a WiFi device, a WiMax device, cellular communication facilities, etc.), and/or the like. The communication unit 1508 may permit data to be exchanged with a network and/or any other devices or systems described in the present disclosure. For example, when the computing system 1500 is included in the pressure system 104 of FIG. 1, the communication unit 1508 may allow the pressure system 104 to communicate with the computing device 140 of FIG. 1 via a network.

Modifications, additions, or omissions may be made to the computing system 1500 without departing from the scope of the present disclosure. For example, in some embodiments, the computing system 1500 may include any number of other components that may not be explicitly illustrated or described.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A system comprising:
one or more computer-readable storage media configured to store instructions; and
one or more processors communicatively coupled to the one or more computer-readable storage media and configured to, in response to execution of the instructions, cause the system to perform operations, the operations comprising:
measuring a pressure of a volume while a user wears a mask and breathes, the volume being defined by an interior surface of the mask and a face of the user;
determining a differential pressure due to the mask, the differential pressure being equal to a difference between the pressure of the volume and an ambient pressure of an environment proximate an exterior surface of the mask; and
determining a mask leakage rate of the mask based on the differential pressure.

2. The system of claim 1, the operations further comprising determining a pressure drop due to the mask based on the differential pressure, wherein the mask leakage rate of the mask is determined based on a difference between the pressure drop and an expected pressure drop due to the mask.

3. The system of claim 2, the operations further comprising:
determining the expected pressure drop; and
determining a flow rate of the mask while the user wears the mask and breathes based on the differential pressure, wherein the pressure drop is determined based on the flow rate of the mask.

4. The system of claim 1, the operations further comprising instructing the user to perform a series of breathing exercises while the user wears the mask, wherein the differential pressure is determined while the user performs the series of breathing exercises.

5. The system of claim 1, the operations further comprising:
instructing the user to perform a series of breathing exercises using a flow meter;
measuring a pressure within a volume defined by the flow meter;
determining a calibrated tidal volume of the user based on the measured pressure;
determining an inhalation flow rate (IFR) of the user and an exhalation flow rate (EFR) of the user based on the calibrated tidal volume;
determining an expected inhalation differential pressure (IDP) based on the IFR and an expected exhalation differential pressure (EDP) based on the EFR; and
determining an IDP due to the mask and an EDP due to the mask, wherein the differential pressure comprises the IDP due to the mask and the EDP due to the mask.

6. The system of claim 5, the operations further comprising:
determining a difference between the IDP and an expected IDP and a difference between the EDP and an expected EDP; and
in response to the difference between the IDP and the expected IDP or the difference between the EDP and the expected EDP being equal to or greater than a threshold value, the operations further comprise determining a fit of the mask and the user fails.

7. The system of claim 1, the operations further comprising:
determining a tidal volume of the user based on at least one of a gender, an age, a height, a weight, a level of physical fitness, a health status, a smoking status, or a chest diameter of the user;
determining an inhalation flow rate (IFR) of the user and an exhalation flow rate (EFR) of the user based on the tidal volume of the user;
determining an expected inhalation differential pressure (IDP) based on the IFR and an expected exhalation differential pressure (EDP) based on the EFR; and
determining an IDP due to the mask and an EDP due to the mask, wherein the differential pressure comprises the IDP due to the mask and the EDP due to the mask.

8. The system of claim 7, the operations further comprising:
determining a difference between the IDP and an expected IDP and a difference between the EDP and an expected EDP; and
in response to the difference between the IDP and the expected IDP or the difference between the EDP and the expected EDP being equal to or greater than a threshold value, the operations further comprise determining a fit of the mask and the user fails.

9. The system of claim 1, the operations further comprising:
determining a tidal volume of the user based on at least one of a gender, an age, a height, a weight, a level of physical fitness, a health status, a smoking status, or a chest diameter of the user;
determining a peak inhalation flow rate (PIFR) of the user and a peak exhalation flow rate (PEFR) of the user based on the tidal volume of the user;
determining an expected peak inhalation differential pressure (PIDP) based on the PIFR and an expected peak exhalation differential pressure (PEDP) based on the PEFR;
determining a PIDP due to the mask and a PEDP due to the mask, wherein the differential pressure comprises the PIDP due to the mask and the PEDP due to the mask;
determining a difference between the PIDP and the expected PIDP and a difference between the PEDP and the expected PEDP; and
in response to the difference between the PIDP and the expected PIDP or the difference between the PEDP and the expected PEDP being equal to or greater than a threshold value, the operations further comprise determining a fit of the mask and the user fails.

10. The system of claim 1, the operations further comprising transmitting data representative of the mask leakage rate of the mask to an external device.

11. The system of claim 1 further comprising:
a micro-electro-mechanical system (MEMS) pressure transducer communicatively coupled to the one or more processors, the MEMS pressure transducer configured to generate data representative of the pressure of the volume while the user wears the mask and breathes;
a frame configured to house at least a portion of the MEMS pressure transducer and to mechanically couple to the MEMS pressure transducer; and
an attachment device mechanically coupled to the frame, the attachment device configured to selectively attach the system to the mask and to physically position the MEMS pressure transducer and frame proximate the interior surface of the mask.

12. A method comprising:
measuring a pressure of a volume while a user wears a mask and breathes, the volume being defined by an interior surface of the mask and a face of the user;
determining a differential pressure due to the mask, the differential pressure being equal to a difference between the pressure of the volume and an ambient pressure of an environment proximate an exterior surface of the mask; and
determining a mask leakage rate of the mask based on the differential pressure.

13. The method of claim 12 further comprising determining a pressure drop due to the mask based on the differential pressure, wherein the mask leakage rate of the mask is determined based on a difference between the pressure drop and an expected pressure drop due to the mask.

14. The method of claim 13 further comprising:
determining the expected pressure drop; and
determining a flow rate of the mask while the user wears the mask and breathes based on the differential pressure, wherein the pressure drop is determined based on the flow rate of the mask.

15. The method of claim 12 further comprising instructing the user to perform a series of breathing exercises while the user wears the mask, wherein the differential pressure is determined while the user performs the series of breathing exercises.

16. The method of claim 12 further comprising:
instructing the user to perform a series of breathing exercises using a flow meter;
measuring a pressure within a volume defined by the flow meter;
determining a calibrated tidal volume of the user based on the measured pressure;
determining an inhalation flow rate (IFR) of the user and an exhalation flow rate (EFR) of the user based on the calibrated tidal volume;
determining an expected inhalation differential pressure (IDP) based on the IFR and an expected exhalation differential pressure (EDP) based on the EFR; and
determining an IDP due to the mask and an EDP due to the mask, wherein the differential pressure comprises the IDP due to the mask and the EDP due to the mask.

17. The method of claim 16 further comprising:
determining a difference between the IDP and an expected IDP and a difference between the EDP and an expected EDP; and
in response to the difference between the IDP and the expected IDP or the difference between the EDP and the expected EDP being equal to or greater than a threshold value, the method further comprises determining a fit of the mask and the user fails.

18. The method of claim 12 further comprising:
determining a tidal volume of the user based on at least one of a gender, an age, a height, a weight, a level of physical fitness, a health status, a smoking status, or a chest diameter of the user;
determining an inhalation flow rate (IFR) of the user and an exhalation flow rate (EFR) of the user based on the tidal volume of the user;
determining an expected inhalation differential pressure (IDP) based on the IFR and an expected exhalation differential pressure (EDP) based on the EFR; and
determining an IDP due to the mask and an EDP due to the mask, wherein the differential pressure comprises the IDP due to the mask and the EDP due to the mask.

19. The method of claim 18 further comprising:
determining a difference between the IDP and an expected IDP and a difference between the EDP and an expected EDP; and
in response to the difference between the IDP and the expected IDP or the difference between the EDP and the expected EDP being equal to or greater than a threshold value, the method further comprises determining a fit of the mask and the user fails.

20. The method of claim 12 further comprising:
determining a tidal volume of the user based on at least one of a gender, an age, a height, a weight, a level of physical fitness, a health status, a smoking status, or a chest diameter of the user;
determining a peak inhalation flow rate (PIFR) of the user and a peak exhalation flow rate (PEFR) of the user based on the tidal volume of the user;
determining an expected peak inhalation differential pressure (PIDP) based on the PIFR and an expected peak exhalation differential pressure (PEDP) based on the PEFR;
determining a PIDP due to the mask and a PEDP due to the mask, wherein the differential pressure comprises the PIDP due to the mask and the PEDP due to the mask;
determining a difference between the PIDP and the expected PIDP and a difference between the PEDP and the expected PEDP; and
in response to the difference between the PIDP and the expected PIDP or the difference between the PEDP and the expected PEDP being equal to or greater than a threshold value, the method further comprises determining a fit of the mask and the user fails.
